(19) United States
(12) Patent Application Publication
(10) Pub. No.: US 2011/0234623 A1
(43) Pub. Date: Sep. 29, 2011

(54) Interface with and communication between mobile electronic devices

(76) Inventor: Michael J. Ure, Cupertino, CA (US)

(21) Appl. No.: 12/671,626

(22) PCT Filed: Jul. 27, 2008
(86) PCT No.: PCT/US08/71282

§ 371 Date: Feb. 1, 2010

Related U.S. Application Data
(63) Continuation of application No. 12/104,392, filed on Apr. 16, 2008.
Application No. 12/104,392 is a continuation of application No. 12/040,769, filed on Feb. 29, 2008.
Application No. 12/040,769 is a continuation of application No. 11/899,756, filed on Sep. 6, 2007, now abandoned.
Application No. 11/899,756 is a continuation of application No. 11/888,811, filed on Aug. 1, 2007.

(51) Int. Cl. G09G 5/02

(52) U.S. Cl. 345/592

(57) ABSTRACT

A method of entering text into a mobile electronic device, comprising: sensing stylus input that is input on a surface through which information displayed on an electronic display is viewed; and displaying on the electronic display an image of the stylus input as it is being input, the image of the stylus input being displayed in a translucent manner so as to less obscure underlying display information. A corresponding mobile electronic device is also described.

### BACKGROUND

1. Field of the Invention

The present invention relates to interface with and communication between mobile electronic devices such as cell phones.

2. State of the Art

User input to mobile electronic devices such as cell phones has been limited by the limited size and capabilities of such devices. Such devices are typically limited to text input and to “linear” graphical user interfaces. Some devices have “mini-QWERTY” keyboards, or thumb pads, wherein separate keys are provided for each letter of the alphabet. These devices tend to be wider than other devices and less comfortable to hold to ones ear for conversation. In other devices, multiple letters share a single key. Text input using these devices tends to be cumbersome. Some devices use no keys at all but use only a touch screen. Tactile feedback is therefore lost.

### SUMMARY

An input device and mobile electronic devices having improved user interface capabilities are described. In one embodiment, a “triple-threat” device is provided in the form of a mobile electronic device of a slider construction. A two-way slider mechanism is provided. In one embodiment, a screen of the mobile electronic device is touch-sensitive (touch input); in a first slider position, tactile-response keys are exposed (key input); in another slider position, a writing pad is exposed (stylus input).

### DESCRIPTION OF DRAWING

The foregoing may be further understood from the following description in conjunction with the appended drawing. In the drawing:

FIG. 1 is a block diagram of a mobile electronic device having improved user interface capabilities.

FIG. 1A is a plan view of one embodiment of the mobile electronic device of FIG. 1.

FIG. 1B is a sectional view of the mobile electronic device of FIG. 1A.

FIG. 1C is a plan view of the mobile electronic device of FIG. 1A in one slider position.

FIG. 1D is a plan view of an alternative embodiment of the mobile electronic device of FIG. 1A in one slider position.

FIG. 1E is a plan view of the mobile electronic device of FIG. 1A in another slider position.

FIG. 1F is an illustration of text entry with translucent display of entered text.

FIG. 1G is a plan view like that of FIG. 1E, showing text entry using a stylus.

FIG. 2 is a diagram of an input device that may be used with the mobile electronic device of FIG. 1.

FIG. 3 is plan view of a portion of a mobile electronic device such as the mobile electronic device of FIG. 1 in one configuration thereof.

FIG. 4 is diagram of a keypad overlay that may be used with the mobile electronic device of FIG. 1.

FIG. 5 is plan view of a portion of a mobile electronic device such as the mobile electronic device of FIG. 1 in another configuration thereof.

FIG. 6 is a plan view of a keypad overlay that may be used with the device of FIG. 5.

FIG. 7 is a perspective view illustrating key operation of the device configuration of FIG. 3 using both thumbs.

FIG. 8 is a perspective view illustrating key operation of the device configuration of FIG. 3 using a stylus.

FIG. 9 is a perspective view illustrating touch operation of the device configuration of FIG. 3 using a finger.

FIG. 10 is a perspective view illustrating key operation of the device configuration of FIG. 5 using both thumbs.

FIG. 11 is another perspective view illustrating key operation of the device configuration of FIG. 5 using both thumbs.

FIG. 12 is a perspective view illustrating touch operation of the device configuration of FIG. 5 using a finger.

FIG. 13 is a perspective view illustrating removal of a keypad overlay from the device configuration of FIG. 3 using thumb and forefinger.

FIG. 14 is a plan view of mobile electronic device provided with an input device like that of FIG. 2.

FIG. 15 is a cross-sectional view of an alternative construction of an input device like that of FIG. 2.

FIG. 16 is a flowchart illustrating text entry.

FIG. 17 is a flowchart of mobile instant messaging using text entry in accordance with FIG. 16.

FIG. 18 is a flowchart of enhanced mobile instant messaging.

FIG. 19 is a flowchart of further enhanced mobile instant messaging.

FIG. 20 is a flowchart of enhanced voice communications.

FIG. 21A is a first diagram illustrating mobile instant messaging using text and graphics input in accordance with FIG. 18.

FIG. 21B is is a second diagram illustrating mobile instant messaging using text and graphics input in accordance with FIG. 18.

FIG. 21C is is a third diagram illustrating mobile instant messaging using text and graphics input in accordance with FIG. 18.

FIG. 22 is a block diagram of a pen equipped with a 3D accelerometer and wireless communication capabilities.

FIG. 23 is a diagram illustrating use of the pen of FIG. 22.

FIG. 24 is a diagram (not to scale) illustrating mechanical details of an Open Mobile I/O interface.

FIG. 25 is a diagram of an untethered electrostatic pen or stylus.

FIG. 26 is a diagram of another untethered electrostatic pen or stylus.

FIG. 27 is a diagram of a pen or stylus having an ink pen attachment.

### DETAILED DESCRIPTION

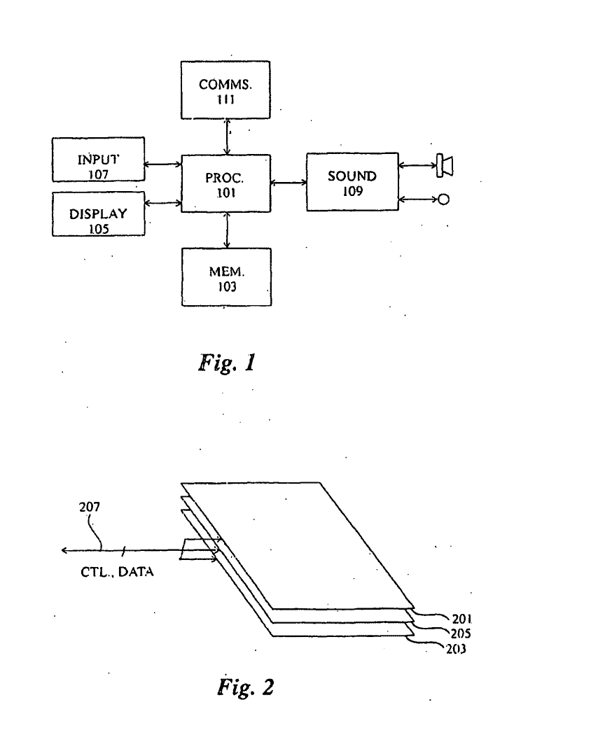

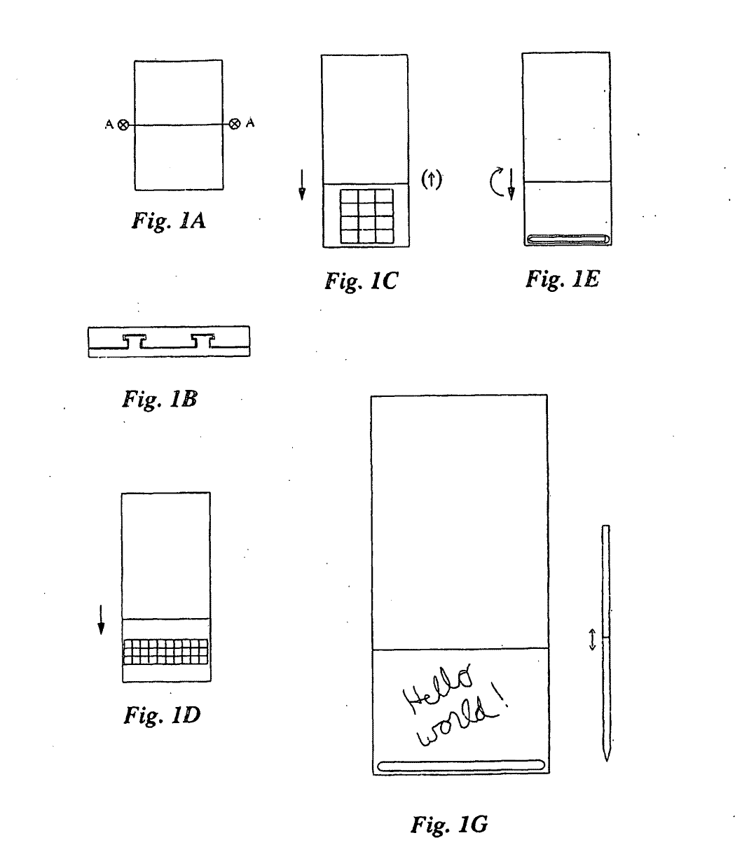

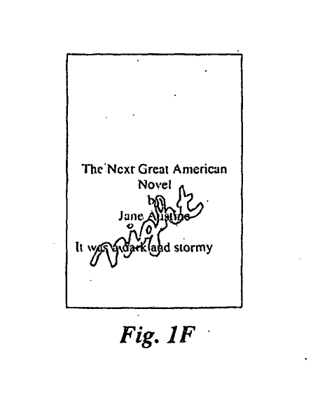

Referring now to FIG. 1, a block diagram is shown of a mobile electronic device having improved user interface capabilities. A processor 101 is coupled to memory 103, to a display sub-system 105, and to an input sub-system 107, described more fully hereinafter. The processor is also coupled to a sound sub-system 109 and a communications sub-system 111.

The input sub-system 107 of the mobile electronic device of FIG. 1 preferably includes both touch input and stylus input capabilities as well as key input capabilities. An exemplary embodiment of such a device is shown in FIGS. 1A-1F.

Referring to FIG. 1A, a plan view is shown of a mobile electronic device having a two-way slider construction. FIG. 1B shows schematically slider elements viewed in section A-A of FIG. 1A. The mobile electronic device may have a touch interface like that of the Apple iPhone.

FIG. 1C shows the slider mechanism extended in one direction to reveal a keypad. The keys are mechanically actuated and incorporate snap key domes or the like to provide satisfactory tactile feedback. If desired, the keypad may also be provided with touch capabilities in a manner known in the art in order to manipulate a cursor or interface tool.

Instead of a keypad, a QWERTY keyboard may be provided as illustrated in FIG. 1D.

FIG. 1E shows the slider mechanism extended in the opposite direction to reveal a writing surface and stylus. The mobile electronic device has been rotated 180 degrees, with the display of information on a main screen of the mobile electronic device taking into account the rotation, in a known manner. If desired, the writing surface may also be provided with touch capabilities in a manner described hereinafter. If touch capabilities for the writing surface are not required, the writing surface may be constructed in a manner described hereinafter except that a touch sensor is omitted.

FIG. 1F illustrates handwriting input using the writing surface. Word-at-a-time or phrase-at-a-time input may be accomplished as described hereinafter.

In yet another embodiment, a keypad is provided and a QWERTY keyboard is provided instead of a writing surface.

The Helio Ocean™ cellphone has more complex dual slider mechanism of a different type. In a “portrait” slider position, a conventional keypad is exposed. In a “landscape” slider position, a QWERTY keyboard is exposed. Three separate housing portions are provided, the main display occupying the topmost main housing portion and the QWERTY keyboard and the conventional keypad occupying different ones of subsidiary housing portions. In another embodiment of the invention, a slider mechanism of this type may be used such that in one slider position (e.g., the landscape position) keys are exposed and in another slider position (e.g., the portrait position) a writing surface is exposed.

Using a slider mechanism to provide a dedicated writing surface is advantageous but adds expense to the device. In a further embodiment, the main device display is provided with stylus input capability as exemplified by Pocket PC™ devices. Word-at-a-time or phrase-at-a-time input may be accomplished as described hereinafter. In one advantageous embodiment, instead of provided a delimited area on the main display in which to enter handwriting, handwriting is allowed over most or all of the surface of the main display. The writing is displayed translucently, without obscuring the underlying display content, as illustrated in FIG. 1G, in which translucent text display is represented by hollow text. Word-at-a-time or phrase-at-a-time input may be accomplished in this manner as described hereinafter.

The input sub-system 107 of the mobile electronic device of FIG. 1 may instead include an input device having both touch input and stylus input capabilities as well as certain display capabilities. One example of such a device is shown in FIG. 2. A clear capacitive touch sensor 201 is provided overlying a resistive sensor or other stylus-responsive sensor 203. Between the capacitive touch sensor 201 and the resistive sensor 203 is provided a display film 205. Control and data signals are exchanged with the input device through a bus 207. A suitable clear capacitive touch sensor 201 is available from Alps Electric of Japan, for example. Such a sensor is constructed by embedding transparent (e.g., indium tin oxide, or ITO) electrodes within a polycarbonate layer. Preferably, the polycarbonate layer is made thinner than normal in order to affect the response of the display film 205 and the resistive sensor 203 as little as possible.

The positions of the display film 205 and the resistive sensor 203 may be interchanged so long as the resistive sensor 203 is made clear allowing the display film 205 to be viewed through it.

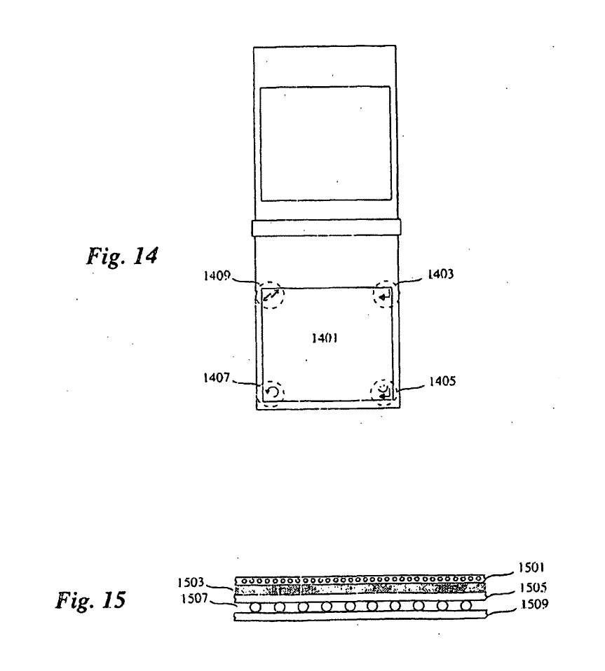

Referring to FIG. 14, a plan view of shown of a mobile electronic device that includes an input device 1401 like that of FIG. 2. The input device is provided in the corners thereof with indicia that serve as user interface icons used for writing capture. Pressing on an icon causes an action to be performed. In an exemplary embodiment, the icons perform the following actions. 1. Icon 1403: Input, recognize (convert to text) and optionally send to a remote user the text written on the input device; clear the display of the input device. 2. Icon 1405: Input and optionally send to a remote user the text or graphics written on the input device (do not perform recognition); clear the display of the input device. 3. Icon 1407: Clear the display of the input device. 4. Icon 1409: Enable communication of stylus input to a remote user in real time. Of course, other specific indicia (icons) and other specific functions may be provided in lieu of or in addition to those described.

In instances where the touch pattern distribution differs between a pen/stylus “touch” and the touch of a human finger, this detectable difference may be taken advantage of in terms of device interaction. In the case of word-at-a-time or phrase-at-a-time text input, instead of the user contacting the pen/stylus at a predetermined location to “enter” (e.g., trigger recognition of) written text that has been input, the user may instead apply a finger touch at any location. In one example, a finger (for example, the side of the little finger, or the tip of the middle finger) is touched to the touch screen without appreciably changing the user's grip on the pen/stylus. Varieties of touches (side, tip, etc.) may be used to represent left click, right click, or other distinguishable user interface commands or actions.

Phrase-at-a-time text input allows for phrase-at-a-time text recognition, wherein text recognition is performed taking into account probabilities of occurrence of word pairs or word tuples.

Referring again to FIG. 2, the display film 207 may be a plastic substrate cholesteric LCD (ChLCD) display film of a type available from Kent Displays Incorporated of Kent Ohio, USA. ChLCDs offer certain advantages in the application of a mobile electronic device. In an exemplary embodiment, the display is a “single-pixel” ChLCD, resulting in low cost. Where cost is not so great an issue, however, the ChLCD display may be a QVGA or similar type of medium or high resolution display. ChLCD displays arc low-power, an important characteristic in mobile applications. They are non-volatile, meaning that display content is persistent without the need for display refresh. Furthermore, they do not require backlighting. Backlights consume considerable power. Finally, for writing capture, a ChLCD configured as described provides immediate response without the need for processor intervention.

Other types of displays, however, including color STN LCD displays, OLED displays, or other color flat-panel displays, may also be used to advantage where cost and power are not so constrained. OLED displays may be particularly well-suited because of their compatibility with plastic substrates. The use of a full-resolution (rather than “single-pixel”) display enables interactive touchpad operation. That is, the touchpad becomes a touchscreen. Of course, medium and high resolution color displays are also visually attractive to the user.

The input device of FIG. 2 may be further optimized for cost reduction and performance. Referring to FIG. 15, a layer 1501 contains embedded ITO electrodes and is used for capacitive touch sensing. In some embodiments, the same ITO electrodes may be used driven by a display driver to produce an image. Beneath the layer 1501 is liquid crystal (e.g., cholesteric liquid crystal) 1503. A layer 1505 cooperates with the layer 1501 to form an envelope for the liquid crystal 1503. The layer 1505 is clear and is provided on the bottom with a coating of conductive paint or ink of a color the same as the desired display color. The coating is connected to electrical ground and also serves as a grounding layer for the resistive sensor. The layer 1509 is a sense layer of the resistive sensor. Between the layers 1505 and 1509 is a layer of elastomeric spacers 1507. By reducing the number of layers of material, cost may be reduced and responsiveness increased.

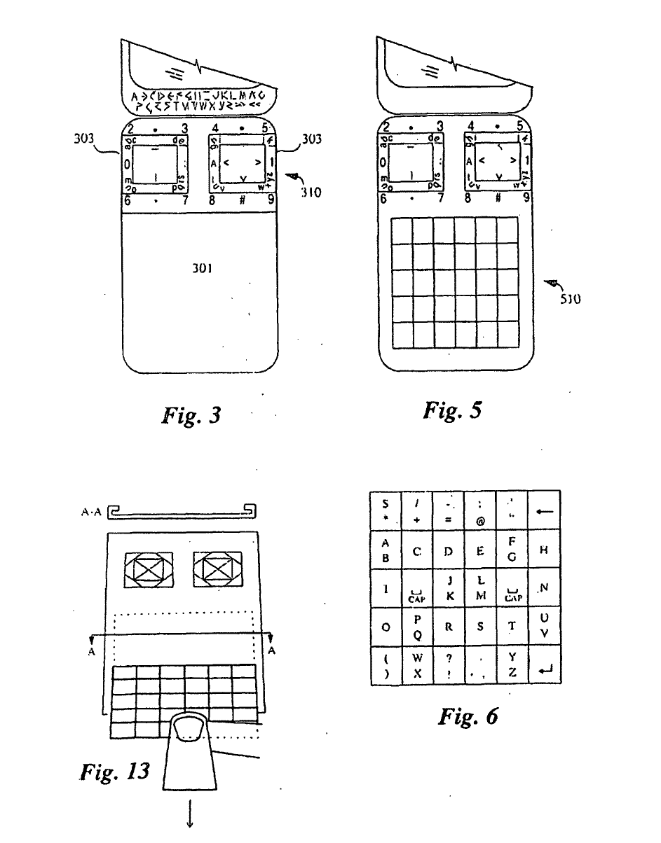

Referring now to FIG. 3, a plan view is shown of one configuration of a portion of a mobile electronic device such as the mobile electronic device of FIG. 1. The mobile electronic device is assumed to use an input device 301 like the input device of FIG. 2. In this configuration, a keypad overlay 310 (to be described) overlies an upper portion of the input device of FIG. 2. A lower portion of the input device remains exposed.

In the illustrated embodiment, the keypad overlay defines two “key complexes” 303 and 305 each of which may be imagined as a four-way rocker switch nested within an eight-way rocker switch for a total of 24 switch inputs. The key complexes exhibit bi-axial symmetry about orthogonal axes. (In other embodiments, the key complexes may actually be realized in the form of rocker switches instead of in the form of a keypad overlay.) FIG. 3 illustrates one example of how indicia may be provided on the keys of the key complexes. Twelve of the keys (0-9, * and #) correspond generally to the number keys and associated keys (*, #) of a typical cell phone. Four of the keys (̂, v, <, >) correspond generally to up, down, left, right keys. Of these same keys, the up arrow may be colored green to allow this same key to be used as the SEND key following entry of a number. The down arrow may be colored red to allow this same key to be used as the END key at the conclusion of a call.

Two upper middle keys (•) are used as “softkeys.” Two keys bear the indicia “|” and “-” respectively. Together with the up, down, left and right keys, these keys may be used to implement the ClickText™ text entry system, described in U.S. Patent Publication 20030030573, incorporated herein by reference. In the ClickText text entry system, two successive key presses are used to unambiguously identify each letter of the alphabet, enabling no-look touch typing. The key combinations are chosen so as to bear a strong resemblance to the capital form of the letter being entered (e.g., [symbol] then - for A). Two keys (;, A) are used for punctuation and case selection. Two keys bear no indicia and are available for other uses.

Although the foregoing key configuration is believed to be advantageous, many other key configurations are also possible.

A keypad overlay is a keypad structure that during use overlies and cooperates with one or more underlying sensors such as the sensors of FIG. 2. The keypad overlay lacks electrical circuits that are closed or opened to cause current to flow or not flow depending on a state of depression of the key domes. Instead, operation of the keys of the keypad overlay is sensed by the underlying sensor(s). As a result, the keypad overlay is removable, and may be interchanged with any of a variety of interchangeable keypad overlays. Keypad overlays may be provided that are specific to a company or team, specific to an application, etc. Unlike software keyboards, tactile feedback is preserved.

When such interchanging of keypad overlays is performed, the change must be communicated to the device software so that the software can correctly sense and interpret key presses. The change can be communicated manually by the user or may be communicated automatically by features of the keypad overlay. For example, the keypad overlay may have the electrical equivalent of a bar code pattern embedded therein and coupled upon insertion into the device to a reference potential (e.g., ground). The capacitive touch sensor may sense the pattern to identify the particular keypad overlay. Alternatively, the device may be provided with Near Field Communications (NFC) capability, and the keypad overlay may have a RFID tag or the like embedded therein.

A suitable keypad overlay may be formed by adapting the teachings of U.S. Patent Publication 20060042923 of De Richecour, assigned to Molex Inc., incorporated herein by reference. Referring to FIG. 4 (corresponding generally to FIG. 2 of De Richecour), an actuator layer is made of a thin plastic film 110 with actuator pins or plungers 115 injected. On the actuator layer 110 are stacked respective layers including: a dome layer comprising a dome support plastic foil 120 supporting a plurality of metal domes 125; a layer of a flex foil 130; an optional layer of an electro-luminescent foil 140; and a layer of a graphic foil 150. On top of the graphic layer 150, at the precise position of the key area, an additional UV ink layer 160 is optionally screen printed for simulating a key button and to tactile engagement with the fingers when touching the key area. Alternatively, a thin thermoformed plastic layer or the like may be provided having elevated key-shaped regions. Note that the circuit layers 131 and 132 of De Richecour are eliminated.

The edges of the keypad overlay are finished using a suitable technique to render them resistant to wear. Preferably, the actuator layer 110 is provided with moderate stiffness so that the keypad overlay retains in substantial degree its planar form when it is withdrawn from the device.

The mobile electronic device may be provided with a “track” into which the keypad overlay is slideably inserted or from which the keypad overlay is slideably removed. Multiple keypad overlays may be used together. If desired, a plastic trim piece may be provided that snaps or slides into the track and covers the bottom edge of one keypad overlay and the top edge of the next keypad overlay so that multiple keypad overlays may be used together without detracting from the aesthetics of the device.

Instead of a keypad overlay, an overlay may in fact not define any keys at all but simply be a touchpad overlay that defines touch areas for a particular application.

Referring again to FIG. 3, it is expected that the keypad overlay 310 would ordinarily be present and would be removed or interchanged infrequently or not at all. In fact, the same or similar key arrangement could be provided in conventional fashion instead of in the form of a keypad overlay. However, a keypad overlay is believed to be advantageous from the standpoint of device construction. Circuit board area that would otherwise be devoted to key contacts may be saved. The design of the plastic of the mobile electronic device may be simplified.

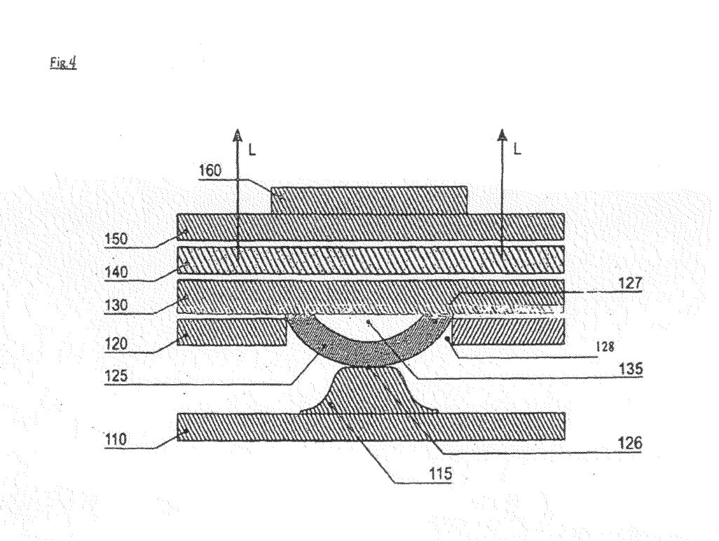

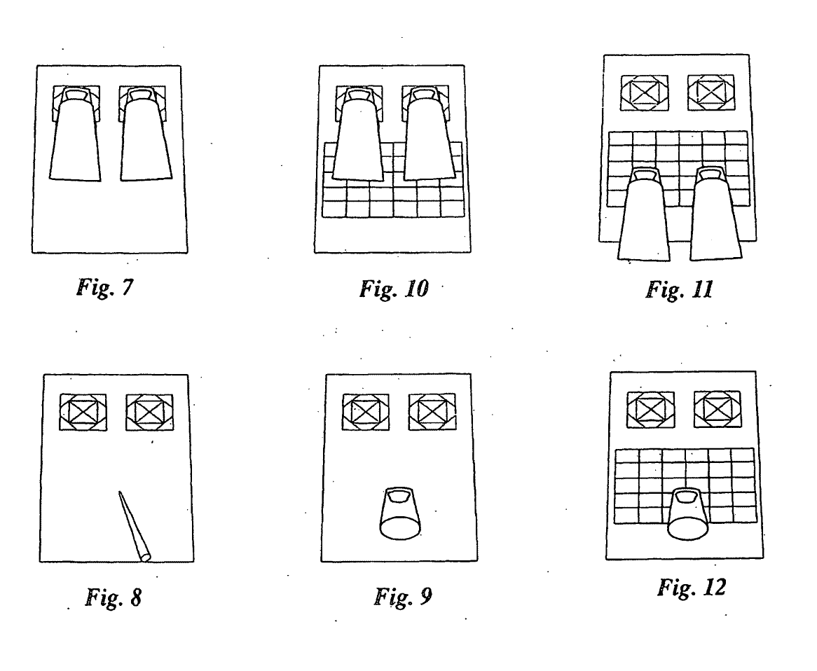

The device configuration of FIG. 3 allows for three different types of user input, or user actions: Click, Write, Point. “Click” refers to key input, illustrated in FIG. 7. “Write” refers to stylus input, illustrated in FIG. 8. The user may use a stylus to write on the surface, the writing being displayed by the ChLCD (for example) and captured by the pressure-sensing layer. “Point” refers to cursoring, navigation and control input using finger, thumb, or both (multi-touch), illustrated in FIG. 9. Touch inputs are sensed by the capacitive touch sensor.

A further device configuration is illustrated in FIG. 5. In this configuration, a second keypad overlay 510 is provided to allow for “Blackberry™-like” text input. In the illustrated embodiment, the second keypad overlay is six keys wide (instead of ten keys wide as is often used). As illustrated in greater detail in FIG. 6, the letters are therefore arranged alphabetically instead of in QWERTY fashion. Some keys bear more than one letter. The letters may be selected between using “touch inflections.” For example, when the lower letter of two letters is desired, the key is pressed and coincident with release of the key, the digit used to depress the key is drawn slightly toward the user. The capacitive touch sensor is able to sense this touch inflection and thereby select the correct letter or other character.

The configuration of FIG. 5 allows for user actions of Click and Point. Key input may be performed using either the first keypad overlay (FIG. 10) or the second keypad overlay (FIG. 11). Pointing may be performed “through” the keypad overlay 510, which is sufficiently thin and sufficiently non-conducting as to not significantly interfere with operation of the capacitive touch sensor, as illustrated in FIG. 12. This configuration typically does not allow for the user action of Write, because of surface contours and sub-surface obstructions of the keypad overlay.

The second keypad overlay 510 may be “stowed” on the rear surface of the mobile electronic device, for example within a track provided on the battery cover lid, when not in use. The keypad overlay 510 is then conveniently available and may be quickly unstowed and slid into place for operation. FIG. 13 illustrates removal of the second keypad overlay 510 for subsequent stowing.

The Apple iPhone has drawn much attention to multi-touch. Multi-touch adds additional cost and raises issues of proprietary rights. It would be useful therefore to achieve the equivalent of multi-touch operation using single-touch technology.

In the iPhone, multi-touch is principally used to zoom and unzoom. The Z-axis sensing capability of single-touch devices may be used to emulate these behaviors. Assume, for example, that touch capability is provided separately from the display. For zoom, the user places a cursor over an area of interest and then lifts off more slowly (more gradually, less abruptly) than would typically be the case. The touchpad senses this slow release and recognizes this as a command to zoom the portion of the display underneath the cursor. The same gesture may be repeated to achieve additional zoom. The user effectively “lifts out” the desired image area from the display. The same effect may be achieved in various other ways, for example by, instead of a gradual release, pausing briefly prior to release. Another example is raising the fingertip into a more vertical position prior to lifting off.

For unzoom, the user places a cursor over an area of interest and then, without lifting off, applies an increment of pressure to the touchpad. The touchpad senses this pressure (increased touch area) and recognizes this as a command to unzoom the portion of the display underneath the cursor. The same gesture may be repeated to achieve additional unzoom. The user effectively “presses in” the desired image area into the display.

Although not a multi-touch behavior, panning may be emulated simply in response to a cursor being moved to an edge area of the display. Panning ensues, and may be discontinued when the cursor is removed from the edge area. Alternatively, panning may be performed in response to a “semi-ballistic” touch having simultaneous rapid Z-variation and XY variation, distinguishing the gesture from normal cursoring. Such a semi-ballistic touch will normally be slightly audible to the user, unlike normal cursoring actions.

The enhanced user input capabilities of the present mobile electronic device enable facile input of both text and graphics.

Because of the non-volatile nature of ChLCD displays, it conveniently serves as a scratchpad/memo-pad. No power is required to preserve the displayed information. An option may be provided to capture and save the displayed information.

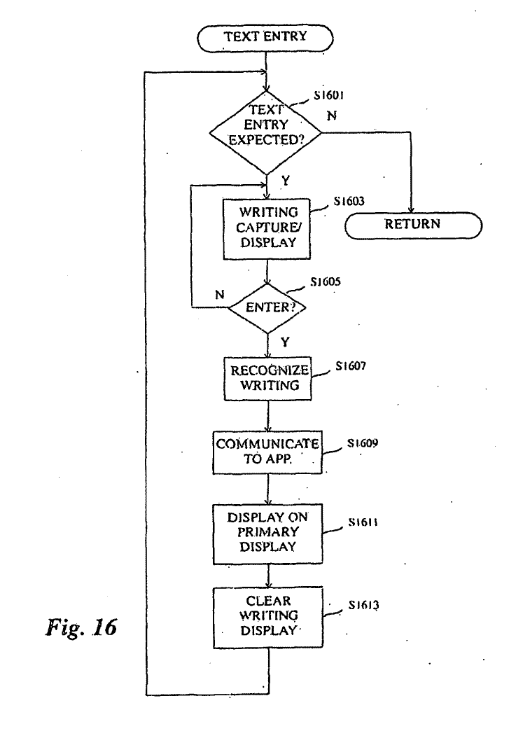

Text entry is made much more facile and rapid. Referring to FIG. 16, in step S1601, the program checks to see whether text entry is expected. If not, program flow returns. If so, writing capture/display is performed (S1603). In step S1605, the program checks to see whether an action equivalent to pressing ENTER on a keyboard has been performed, for example activating the icon 1403 (FIG. 14). If not, writing capture/display continues. If so, recognizer software processes the captured input to recognize the user's writing and convert it to text (S1607). The text is communicated to the current application (S1609) and displayed on the primary display (S1611). The writing display is then cleared (S1613). The same flow is then repeated.

Various text recognition modes may be provided suited to handwriting styles having varying degrees of distinctness. Users with a fairly distinct hand should be able to write freely, activating the icon 1403 (FIG. 14) when the available writing space is filled. Other users may benefit from additional assistance. For example, a “word-at-a-time” mode may be provided in which the user activates the icon 1403 following each word. Segmenting input by word aids the recognizer to accomplish accurate recognition. Also, a “dotting” mode may be provided in which the user writes a dot following each word, to the same effect. For users having handwriting that is overly difficult to recognize, the user may activate the icon 1405, causing the handwriting to be stored and/or sent as an image without recognition.

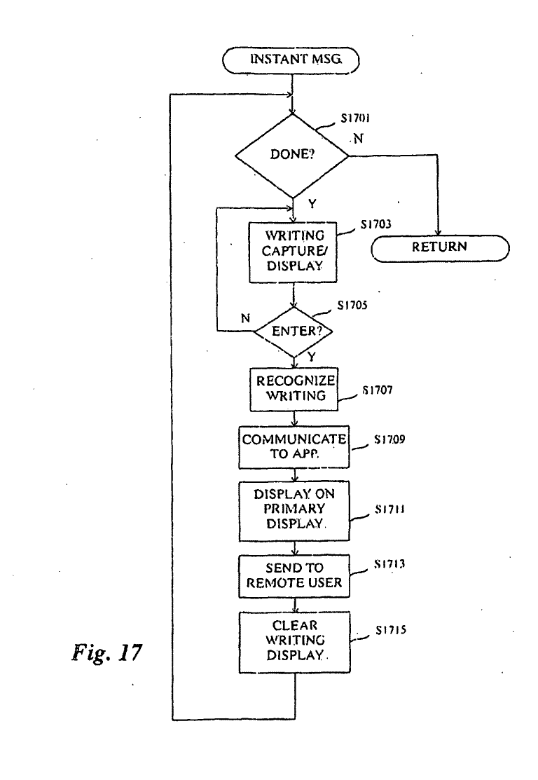

Enhanced text entry capabilities find particular use in mobile instant messaging. Referring to FIG. 17, in step S1701, the program checks to see whether it is finished. If so, program flow returns. If not, writing capture/display is performed (S1703). In step S1705, the program checks to see whether an action equivalent to pressing ENTER on a keyboard has been performed, for example activating the icon 1403 (FIG. 14). If not, writing capture/display continues. If so, recognizer software processes the captured input to recognize the user's writing and convert it to text (S1707). The text is communicated to the current application (S1709) and displayed on the primary display (S1711). The text is communicated to a remote user as part of an instant messaging session (S1713). The writing display is then cleared (S1615). The same flow is then repeated.

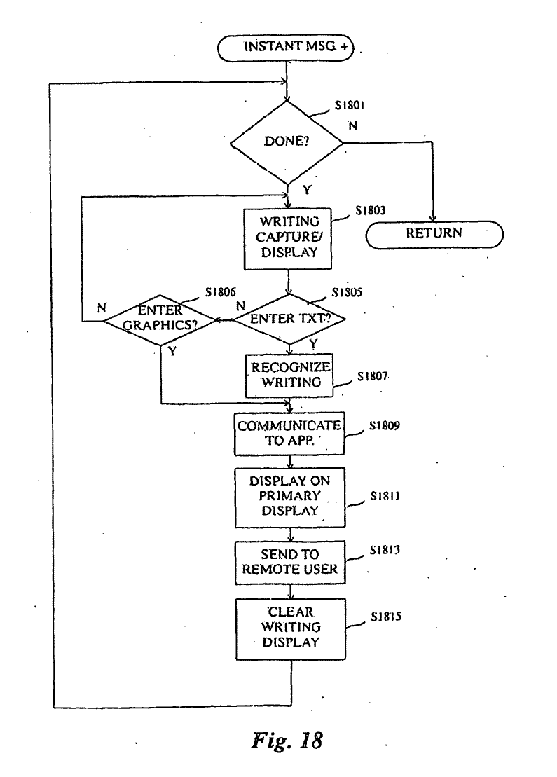

Mobile instant messaging may be further enhanced by provided for graphics (Instant Messaging Plus™). Referring to FIG. 18, in step S1801, the program checks to see whether it is finished. If so, program flow returns. If not, writing capture/display is performed (S1803). In step S1805, the program checks to see whether an action equivalent to pressing ENTER on a keyboard has been performed, for example activating the icon 1403 (FIG. 14). If so, recognizer software processes the captured input to recognize the user's writing and convert it to text (S1807). If not, the program further check to see whether an action for entering graphics has been performed, for example activating the icon 1405 (FIG. 14). If not, writing capture/display continues. The text or graphics is communicated to the current application (S1809) and displayed on the primary display (S1811). The text or graphics is communicated to a remote user as part of an instant messaging session (S1813). The writing display is then cleared (S1815). The same flow is then repeated.

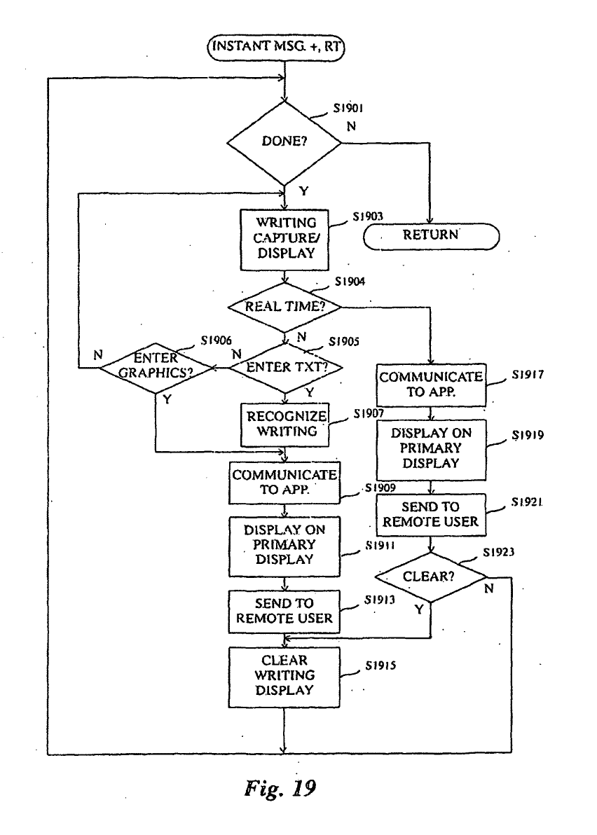

Instead of graphics information being communicated to the remote user at the command of the user, it may be communicated to the remote user in real time. An element of anticipation is created as the remote user observes in real time another user producing a graphic or drawing. Such real time communication of graphics information may be performed by adapting or extending existing messaging protocols. Referring to FIG. 19, in step S1901, the program checks to see whether it is finished. If so, program flow returns. If not, writing capture/display is performed (S1903). In step S1904, the program checks to see whether a real time mode is in effect.

If not, a first series of steps ensues. In step S1905, the program checks to see whether an action equivalent to pressing ENTER on a keyboard has been performed, for example activating the icon 1403 (FIG. 14). If so, recognizer software processes the captured input to recognize the user's writing and convert it to text (S1907). If not, the program further check to see whether an action for entering graphics has been performed, for example activating the icon 1405 (FIG. 14). If not, writing capture/display continues. The text or graphics is communicated to the current application (S1909) and displayed on the primary display (S1911). The text or graphics is communicated to a remote user as part of an instant messaging session (S1913). The writing display is then cleared (S1915). The same flow is then repeated.

If in step S1904 real time mode is found to be in effect, a second series of steps ensues. Graphics information is communicated to the current application (S1917) and displayed on the primary display (S1919). The graphics information is communicated to a remote user as part of an instant messaging session (S1921). The program then checks to see whether an action for clearing the writing display has been performed, for example activating the icon 1407 (FIG. 14). Depending on whether the action for clearing the writing display has been performed, the writing display is either cleared (S1915) or not cleared. The same flow is then repeated.

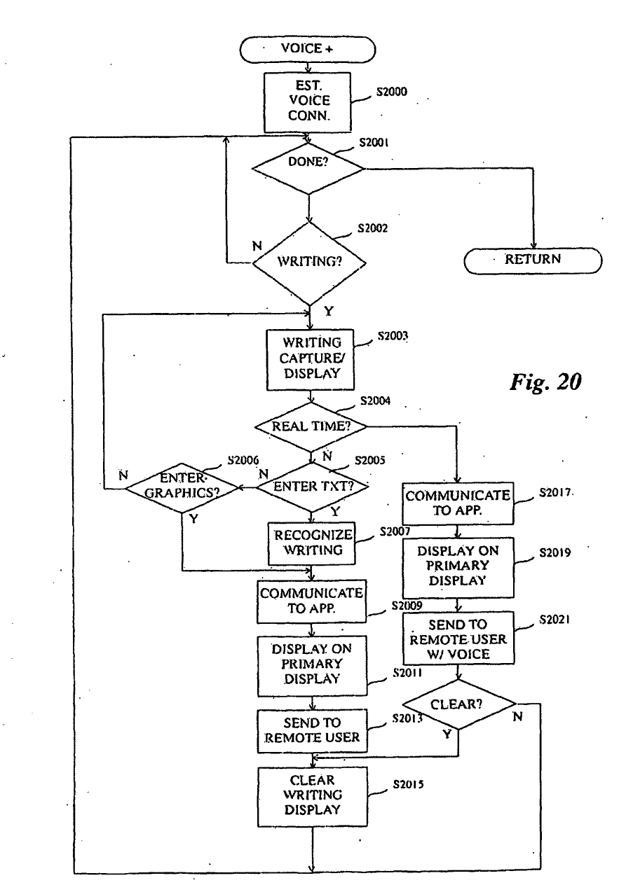

Voice communications may also be enhanced by simultaneous communication of text or graphics (Voice Plus™). Referring to FIG. 20, first, in step S2000, a voice connection is established. Then in step S2001, the program checks to see whether it is finished. If so, program flow returns. If not, the program check to see whether writing has been initiated (S2002). If not, the program again checks to see whether it is finished (S2001). If writing has been initiated, then writing capture/display is performed (S2003). In step S2004, the program checks to see whether a real time mode is in effect.

If not, a first series of steps ensues. In step S2005, the program checks to see whether an action equivalent to pressing ENTER on a keyboard has been performed, for example activating the icon 1403 (FIG. 14). If so, recognizer software processes the captured input to recognize the user's writing and convert it to text (S2007). If not, the program further check to see whether an action for entering graphics has been performed, for example activating the icon 1405 (FIG. 14). If not, writing capture/display continues. The text or graphics is communicated to the current application (S2009) and displayed on the primary display (S2011). The text or graphics is communicated to a remote user as part of an instant messaging session (S2013). The writing display is then cleared (S2015). The same flow is then repeated.

If in step S2004 real time mode is found to be in effect, a second series of steps ensues. Graphics information is communicated to the current application (S2017) and displayed on the primary display (S2019). The graphics information is communicated to a remote user as part of an instant messaging session (S2021). The program then checks to see whether an action for clearing the writing display has been performed, for example activating the icon 1407 (FIG. 14). Depending on whether the action for clearing the writing display has been performed, the writing display is either cleared (S2015) or not cleared. The same flow is then repeated.

The simultaneous communication of voice and graphics may be accomplished, for example, using the technique of U.S. Patent Publication 20050147131 of Greer, assigned to Nokia, which is incorporated herein by reference. As described therein, a small number of vocoder bits are “stolen” and used provide a low-rate data channel without appreciable effect on voice quality. Some systems, including UMTS, may permit separate simultaneous voice and data connections, in which case the technique of Greer may not be needed.

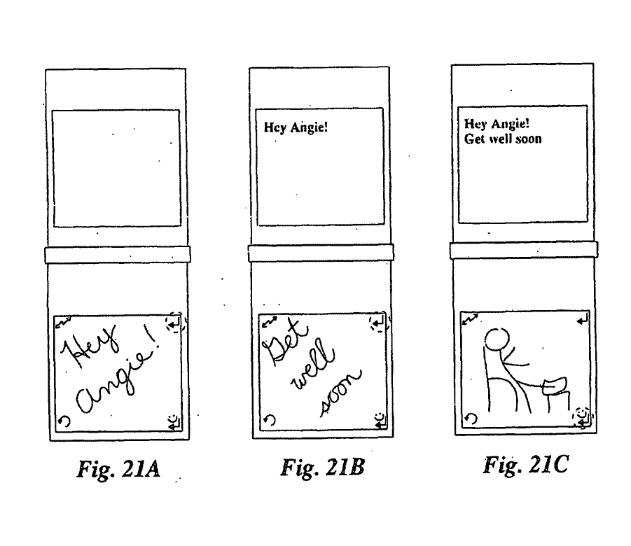

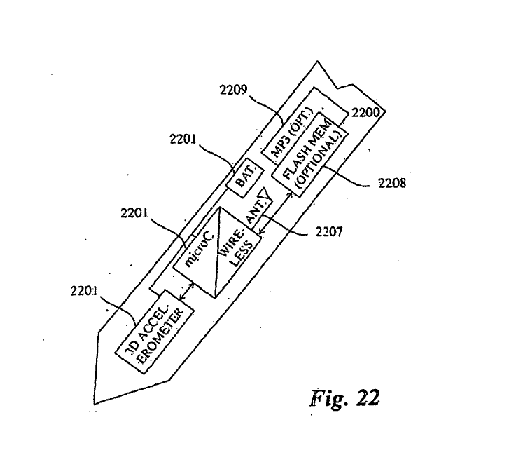

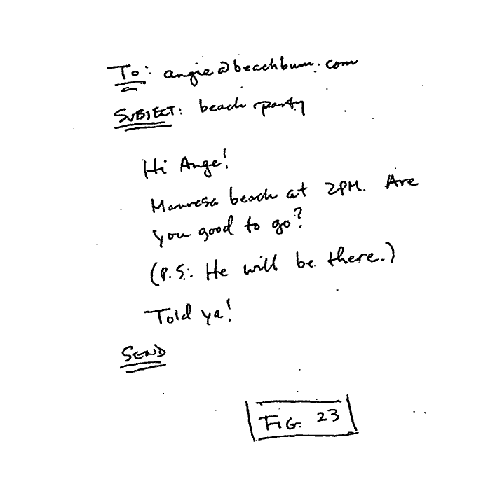

An illustration of mobile instant messaging using text and graphics entry in accordance with FIG. 18 is shown in FIGS. 21A, 21B and 21C. As shown in FIG. 21A, the user first writes “Hey Angie!” and activates the icon 1403 (FIG. 14). In response, the written text is recognized, displayed and sent to the remote user (Angie). As shown in FIG. 21B, the user then writes “Get well soon” and activates the icon 1403. The written text is recognized, displayed and sent to Angie. As shown in FIG. 21C, the user then draws a picture representing Angie's condition. The user activates the icon 1405. In response, the graphic is displayed (possibly in thumbnail form, although not shown) and sent to Angie.

As has been described in the foregoing, a mobile electronic device may be provided that receives user input primarily or exclusively through planar sensors. Futhermore, a connectorization and communication standard may be defined for mobile phone “flat panel peripheral devices,” or FPDevs, thereby achieving Open Mobile Input or Open Mobile I/O. An FPDev has a principal surface (defined as one of two surfaces having a greatest area) exposed to the user and becomes part of the mobile phone (or other mobile electronic device) on temporary basis, either long-term or short-term. An example of an FPDev is a combination touchpad/stylus pad. Another example is a touchpad/stylus pad with display capabilities.

An integrated peripheral device may further enable various “input accessories” to be used. An example of an input accessory is a keypad overlay that incorporates key domes and hence provides tactile feedback but that has no electrical function. Input is accomplished through the action of an FPDev, for example through the pressure-sensing action of a stylus pad.

The connector arrangement should provide power, ground and data connections. It may also provide a clock connection. For purposes of input, the data rate required is fairly low—below 100 kbps. Any of a variety of known protocols may be used, including, for example, the I2C protocol.

The connector height on the FPDev side should be about 1 mm or less. The MicroUSB connector is one suitable candidate. Positive insertion may be provided for on the mobile side such that the user knows when insertion has been accomplished. In a basic form, the connector may simply be a miniaturized edge connector having four traces.

The FPDev may optionally be provided with wireless connectivity, e.g., Bluetooth or wireless USB (WUSB). Incorporating wireless connectivity in an FPDev, including wireless connectivity that supports real-time video transer, will become increasingly easy. The interface then becomes not just an input interface but also an output interface. One can imagine, for example, plugging in a specialized display, such as a 3D display.

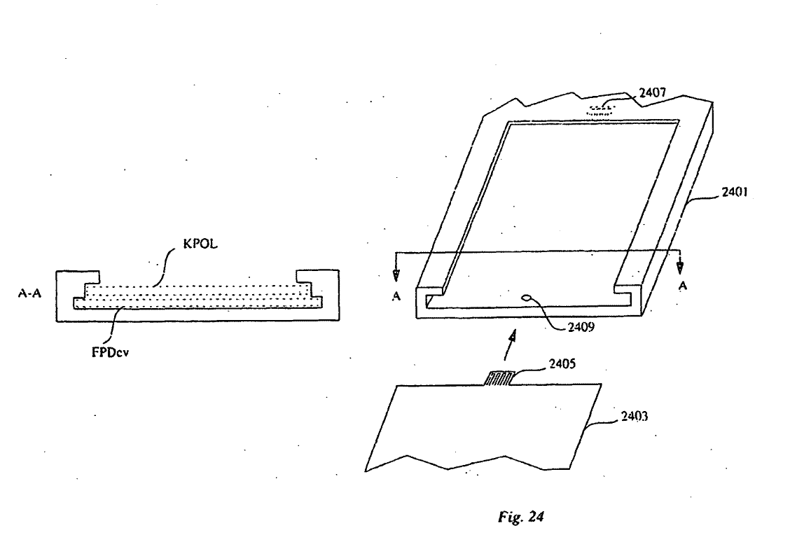

Referring to FIG. 24, in one embodiment, the base portion 2401 of the phone has a “sled” construction, or sled-like structure, that allows an FPDev 2403 to be inserted. The FPDev may have embedded within it one or more integrated circuits (not shown) that control the functions of the FPDev. The term “sled” is used here to connote that the FPDev slides into the base without being enclosed by it. The FPDev is provided with a male connector 2405, and the base is provided with a mating female connector 2407. Alternatively, the base may be provided with a male connector, and the FPDev may be provided with a mating female connector 2407. As shown in the cross-section, the channels that receive the FPDev may be stepped to allow a keypad overlay (KPOL) to be received above the FPDev. If desired, a break-away trim piece may be provided that covers the ends of the channels, the inserted FPDev, and the inserted keypad overlay, if any. A mic aperture may be provided so as to not interfere with operation of a mic 2409. Various other standard connectors (not shown) may be provided at the end of the base portion 2401.

The foregoing methods works well within the confines of the limited screen size of the device. These limitations may be overcome at least in part using a pen equipped with a 3D accelerometer and wireless communications capabilities. Such a pen 2200 is illustrated in FIG. 22. It includes a 3D accelerometer 2201, a microcontroller provided with wireless communications capabilities (e.g., Bluetooth, UWB, Zigbee, etc.) 2203, a battery 2205, and an antenna 2207. Mechanical features of the pen such as an ink reservoir are not shown. Optionally, one or more input buttons or other inputs to the microcontroller may be provided. The pen may also be provided with flash memory 2208 and a USB interface to enable it to function as a memory stick or even as an MP3 player (2209).

The pen is used with plain paper to interface to a mobile electronic device provided with similar wireless communications capabilities. The term “plain paper interface” may therefore be used to describe this manner of operation.

As a user uses the pen to write on a plain piece of paper, writing capture occurs through the mechanism of the 3D accelerometer and wireless communications. That is, data from the 3D accelerometer describing motion of the pen is wirelessly communicated to the mobile electronic device (not shown). A recognizer may receive the input from the 3D accelerometer and perform handwriting recognition thereon. While the writing will typically be displayed on the main display of the mobile electronic device, the user will have less need to refer to the display except to resolve ambiguities in recognition. Commands may be input to the mobile electronic device through the plain paper interface using one or more signifiers. For example, double-underlining may be used to identify text as a command or as text having special significance for program operation.

Referring to FIG. 23, an example is shown of using plain paper interface to send an email. The user writes “TO”, upon which the mobile electronic device recognizes that the user wishes to send an email. The mobile electronic device prompts the user to enter an email address using an address book of the mobile electronic device, separate and apart from the plain paper interface. In the illustrated example, the desired address is not in the address book. The user therefore ignores the prompt and enters the desired address through the plain paper interface. The user may also enter “CC” addresses and the like in the same or similar manner. The user then writes “SUBJECT” followed by the subject of the email. The user then enters the text of the email. To attach an attachment, the user writes “ATTACH”. The mobile electronic device then prompts the user to select one or more attachments, separate and apart from the plain paper interface. Finally, the user writes “SEND”. The email is then sent.

Note that all of the features previously described (Instant Messaging Plus, Voice Plus, etc.) may be used together with plain paper interface methods, the principal difference being that writing capture occurs through the mechanism of the 3D accelerometer and wireless communications.

The well-known Apple iPhone™ cellphone has a capacitive touch-screen interface designed to respond to finger touches but not to stylus input using, for example, a plastic stylus or the like. The Apple Newton™ personal digital assistant, on the other hand, had a pressure-sensitive touch-screen interface designed to respond to stylus input using a plastic stylus but not to finger touches.

An untethered electrostatic pen/stylus for use with capacitive touch sensors, described herein, allows for a single device like the iPhone to receive input via both finger touches and a stylus. Stylus input is more precise for various uses including, for example, text input and drawing input.

Other features and advantages will be understood upon reading and understanding the detailed description of exemplary embodiments, found herein below, in conjunction with reference to the drawings, a brief description of which is provided below.

There follows a more detailed description of the present invention. Those skilled in the art will realize that the following detailed description is illustrative only and is not intended to be in any way limiting. Other embodiments of the present invention will readily suggest themselves to such skilled persons having the benefit of this disclosure. Reference will now be made in detail to embodiments of the present invention as illustrated in the accompanying drawings. The same reference indicators will be used throughout the drawings and the following detailed description to refer to the same or like parts.

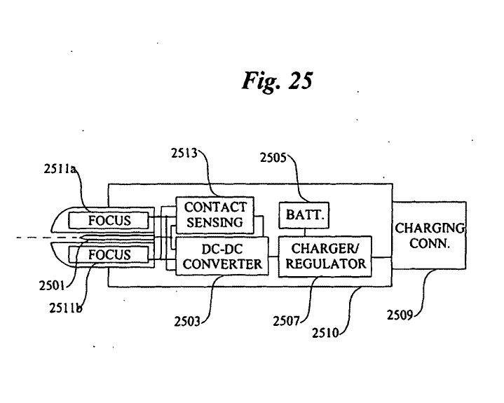

Referring now to FIG. 25, a diagram is shown of an untethered electrostatic pen/stylus for use with capacitive touch sensors. A sharp-tipped field-emission electrode 2501 is connected to a high voltage (e.g., 100-1000V or more) produced by a DC-DC converter 2503 of a known type (for example, a Q Series ultra-miniature DC to HV DC converter available from EMCO High Voltage Corporation of Sutter Creek, Calif.). The DC-DC converter is supplied with power from a battery 2505 by a charger/regulator block 2509. The charger/regulator block is connected to a charging connection 2501 mounted so as to be accessible from outside a housing 2510. Application of a high voltage to the field-emission electrode causes an electron beam to be emitted. Adjacent to and possible surrounding the field-emission electrode is one or more electron beam focusing elements 2511a, 2511b forming an electron beam lens. Various types of electron beam lens, such as the Einzel electron beam lens, are known in the art.

The DC-to-DC converter may use a step-up transformer or may be realized primarily in the form of an integrated circuit.

Also provided is a contact sensor 2513. The function of the contact sensor is to sense when a tip of the untethered electrostatic pen/stylus has been brought into contact with or removed from contact with a surface, i.e., the surface of a capacitive touch sensor. During contact, the high voltage is applied to the field-emission electrode. During the absence of such contact, the high voltage is not applied to the field-emission electrode. The contact sensor may take any of various forms, including for example a microswitch, an optoelectronic switch, an oscillator and counter, an acoustic impedance sensor, etc.

In one embodiment, the untethered electrostatic pen/stylus may take a similar form as a USB drive, with the charging connector being a USB connector. The untethered electrostatic pen/stylus may therefore be easily charged from a PC or other line powered or battery powered electronic device. A snap-on cap may be provided that covers the field-emission electrode and surrounding structure.

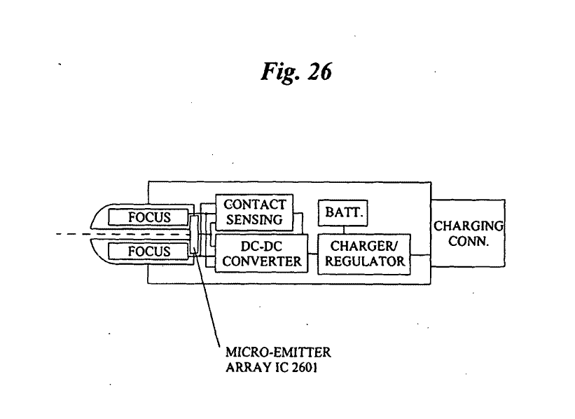

Referring to FIG. 26, another embodiment of a untethered electrostatic pen/stylus is shown. In this embodiment, the field-emission electrode is replaced by an integrated circuit 2601 having formed thereon a field-emission array having hundreds, thousands, or even tens of thousands of individual micro-emitters. The micro-emitters may be formed within a vacuum envelope and emit through a sealed “window” that is relatively transparent to electron emission (e.g., a layer of silicon a few microns thick) as described for example in U.S. Pat. No. 6,714,625 entitled Lithography Device for Semiconductor Circuit Pattern Generation, issued Mar. 30, 2004, incorporated herein by reference. Alternatively, a microemitter may be formed as described in “Miniature Electron Microscopes Without Vacuum Pumps, Self-Contained Microfabricated Devices with Short Working Distances, Enable Operation in Air,” NASA Tech Briefs, 39-40 (1998), set forth in Appendix A.

The untethered electrostatic pen or stylus may incorporate the features of a USB “thumb drive” or other similar devices.

Furthermore, the pen or stylus may take the form of a USB thumb drive but use a different location mechanism than the electrostatic mechanism described. For example, the pen or stylus may use an electromagnetic location mechanism in which a coil located in the vicinity of a display produces an excitation signal that excites a response in a resonant circuit located in the pen or stylus. The response is detected by an array of detectors arrayed in relation to the surface of the display, so as to detect the location of the pen or stylus.

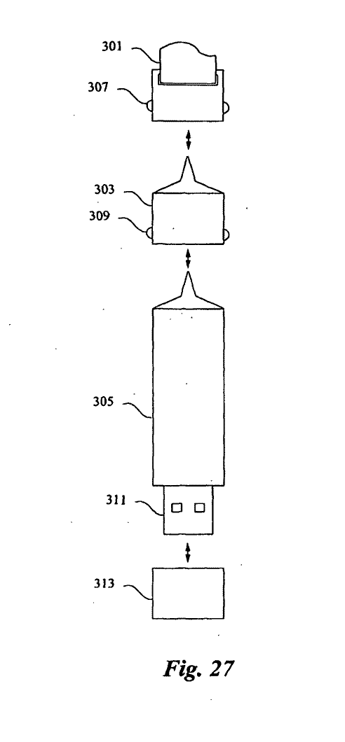

Referring to FIG. 27, in a further embodiment, a lanyard 301 and a replaceable ink pen attachment 303 are provided to be used in conjunction with the pen or stylus 305. The ink pen attachment clips into the lanyard, and the pen or stylus clips into the ink pen attachment. By pressing a selected one of two release mechanisms 307 and 309, the pen or stylus can be readied for use either as an ink pen with the ink pen attachment attached or as a pen or stylus for input to a device, without the ink pen attachment attached. For purposes of illustration, a USB connector 311 and a cap 313 are also shown.

In other embodiments, the ink pen mechanism may be provided as part of the pen or stylus instead as of an attachment. For example, the ink pen mechanism may be located at the opposite end of the pen or stylus as the end used to interact with a mobile electronic device. A USB connector or the like may be located elsewhere if needed, and be articulatable if needed.

Although embodiments of the present invention have been described in detail, it should be understood that various changes, substitutions and alternations can be made without departing from the spirit and scope of the inventions as defined by the appended claims.

### Appendix 2: Additional Aspects of Invention

1.1. A pen or stylus for interacting with a capacitive touch sensor, comprising:

an elongated housing having a grip area to be gripped in a writing grip; and

an electron beam source within the elongated housing.
1.2. The apparatus of 1.1, wherein the electron beam source comprises a field-emission electrode.
1.3. The apparatus of 1.2, wherein the electron beam source comprises a field-emission array of micro-emitters.
1.4. The apparatus of 1.1, comprising an electron beam lens for focusing an electron beam produced by the electron beam source.
1.5. The apparatus of 1.1, comprising a rechargeable battery and a charging connector.
1.6. The apparatus of 1.1, wherein the charging connector is a USB connector.
1.7. The apparatus of 1.1, comprising a contact switch responsive to contact of the pen/stylus for causing supply of a high voltage to the electron beam source to be interrupted during absence of contact.
1.8. A pen or stylus for interacting with a mobile electronic device, comprising:

an elongated housing having a grip area to be gripped in a writing grip;

electronic circuitry within the elongated housing, comprising a resonant circuit responsive to an applied electromagnetic excitation to produce a responsive signal; and

a bus connector coupled to the electronic circuitry.
1.9. The apparatus of 1.8, wherein the bus connector is a USB connector.
1.10. A pen or stylus for interacting with mobile electronic device and for writing in ink, comprising:

an elongated housing having a grip area to be gripped in a writing grip;

electronic circuitry within the elongated housing for producing a signal for detecting a location of the pen or stylus;

a bus connector coupled to the electronic circuitry; and

a mechanism for attaching an ink pen attachment.
1.11. The apparatus of 1.10, wherein the bus connector is a USB connector.
1.12. A pen or stylus for interacting with mobile electronic device and for writing in ink, comprising:

an elongated housing having a grip area to be gripped in a writing grip;

electronic circuitry within the elongated housing for producing a signal for detecting a location of the pen or stylus; and

an ink pen mechanism providing the function of an ink pen.
1.13. The apparatus of 1.12, further comprising a bus connector coupled to the electronic circuitry.
1.14. The apparatus of 1.13, wherein the bus connector is a USB connector.
2.1. A mobile electronic device having touch input, key input and stylus input, comprising:

a first housing portion housing a main display;

at least one additional housing portion coupled to the first housing portion to enable two-way slider motion between the first housing portion and the at least one additional housing portion;

keys provided on the at least one additional housing portion, the keys being exposed in a first slider position; and

a writing surface provided on the at least one additional housing portion, the keys being exposed in a second slider position.
2.2. A mobile electronic device having touch input, key input and stylus input, comprising:

a first housing portion housing a main display;

at second housing portion coupled to the first housing portion to enable two-way slider motion between the first housing portion and the second housing portion;

a keypad provided on the second housing portion, the keypad being exposed in a first slider position obtained by relative motion between the first and second housing portions in a first direction; and

a QWERTY keyboard provided on the second housing portion, the QWERTY keyboard being exposed in a second slider position obtained by relative motion between the first and second housing portions in a direction opposite said first direction.
3.1. An input device comprising:

a display device;

a capacitive touch sensor overlying the display device; and

a pressure-sensing layer underlying or overlying the display device.
3.2. The apparatus of 3.1, wherein the pressure-sensing layer is a resistive sensor.
3.3. The apparatus of 3.1, wherein the display device is non-volatile.
3.4. The apparatus of 3.1, wherein the display device directly captures and displays writing in response to applied pressure.
3.5. The apparatus of 3.1, wherein the display device is a cholesteric liquid crystal display.
3.6. The apparatus of 3.1, wherein indicia are visible on the capacitive touch sensor, indicative of at least one of the following functions: enter/send; recognize handwriting then enter/send; and, clear display.
3.7. A mobile electronic device comprising:

a first housing portion and a second housing portion connected together in a hinged manner;

a display housed by the first housing portion; and

a pressure-sensing layer housed by the second housing portion for performing writing capture in response to a stylus.
3.8. The apparatus of 3.7, comprising a capacitive touch sensor housed by the second housing portion.
3.9. The apparatus of 3.8, wherein indicia are visible on the capacitive touch sensor, indicative of at least one of the following functions: enter/send; recognize handwriting then enter/send; and clear display.
3.10. The apparatus of 3.8, comprising a keypad overlay delineating multiple key areas and overlying at least a portion of the capacitive touch sensor.
3.11. The apparatus of 3.10, wherein the keypad overlay comprises at least one flexible key dome, wherein depression of the flexible key dome is sensed by at least one of the pressure-sensing layer and the capacitive touch sensor.
3.12. A method of inputting information to a mobile electronic device having a primary display, comprising:

sensing stylus input of multiple words written on a pressure-sensitive layer located separate and apart from the primary display;

displaying the words on a secondary display situated in overlapping relation to the pressure-sensitive layer;

sensing a stylus input occurring in a particular area; and

in response to the stylus input, displaying the words on the primary display.
3.13. A method of performing instant messaging using a mobile electronic device, comprising:

sensing stylus input of multiple words written on a pressure-sensitive layer located separate and apart from the primary display;

displaying the words on a secondary display situated in overlapping relation to the pressure-sensitive layer;

sensing a stylus input occurring in a particular area; and

in response to the stylus input, sending the words as part of a message to a remote device.
3.14. The method of 3.13, comprising, prior to sending the words as part of a message, performing handwriting recognition to recognize the words.
3.15. The method of 3.13, wherein the words are sent as a graphic image.
3.16. A method of performing messaging using a mobile electronic device, comprising:

sensing stylus input written on a pressure-sensitive layer located separate and apart from the primary display;

displaying the input on a secondary display situated in overlapping relation to the pressure-sensitive layer; and

in response to and concurrent with the stylus input, sending information capturing the stylus input to a remote device.
3.17. A method of graphics-augmented voice communications using a mobile electronic device, comprising:

establishing a voice connection between the mobile electronic device and a remote device; and

during the course of the voice connection:
sensing stylus input written on a pressure-sensitive layer located separate and apart from the primary display;
displaying the input on a secondary display situated in overlapping relation to the pressure-sensitive layer; and
in response to and concurrent with the stylus input, sending information capturing the stylus input to the remote device.
3.18. A keypad overlay for use with a mobile electronic device, comprising:

a first member providing a flat surface;

a second member having indicia formed thereon; and

a plurality of flexible key domes provided between the first member and the second member;

the keypad overlay lacking electrical circuits that are closed or opened to cause current to flow or not flow depending on a state of depression of the key domes.
3.19. A method of inputting information to a mobile electronic device using a writing instrument having a movement sensor, a radio link being provided between the mobile electronic device and the writing instrument, the method comprising:

sensing movement of the writing instrument during writing on a plain piece of paper using the writing instrument; and

communicating said movement to the mobile electronic device.
3.20. The method of 3.19, comprising:

sensing movement of the writing instrument during writing of a command and communicating said command to the mobile electronic device; and

the mobile electronic device executing said command.
3.21. A method of sending a message, comprising:

establishing a communication session;

capturing stylus input; and

as part of the communications session, sending a representation of the captured stylus input.
3.22. The method of 3.21, wherein the representation is a textual representation.
3.23. The method of 3.21, wherein the representation is a graphical representation.
3.24. The method of 3.23, wherein the graphical representation is sent in real time and displayed as a succession of images, each successive image updating a prior image.
3.25. The method of 3.21, wherein the communications session includes voice communications.
3.26. A key assembly comprising a key complex having four key switches nested inside eight key switches, the key complex exhibiting bi-axial symmetry about orthogonal axes.
3.27. The apparatus of 3.26, comprising a further key complex having four key switches nested inside eight key switches, the further key complex exhibiting bi-axial symmetry about orthogonal axes.
3.28. The apparatus of 3.1, wherein the pressure-sensing layer underlies the display device.
3.29. A mobile electronic device that accepts each of a plurality of different keypads each having a different key configuration.
3.30. A method of inputting text to a mobile electronic device, comprising:

capturing writing of a user in response to a pen or stylus;

receiving pen or stylus inputs from the user indicative of word separation; and

performing recognition of captured writing using said inputs indicative of word separation.
3.31. The method of 3.30 wherein the user activates an icon following input of each individual word.
3.32. The method of 3.30, wherein the user inputs a dot following each individual word.
3.33. A method of inputting information to a mobile electronic device, comprising:

sensing depression of a key using at least one of a capacitive touch sensor and a pressure sensor; and

upon release of the key input, sensing whether lateral motion of a digit of a user with respect to a surface of the key occurs;

if lateral motion is sensed to have occurred, inputting first information; and

if lateral motion is not sensed to have occurred, inputting second information.
3.34. An accessory for a mobile electronic device, the accessory comprising:

a pen mechanism;

a microcontroller; and

a wireless transmitter or transceiver coupled to the microcontroller;
3.35. The accessory of 3.34, further comprising flash memory and a USB port, whereby the accessory functions as a memory stick.
3.36. The accessory of 3.34, further comprising flash memory, MP3 player electronics, and a USB port, whereby the accessory functions as an MP3 player.
3.37. A mobile electronic device comprising:

a housing;

a display; and

a structure for receiving, securing and connecting a flat peripheral device such that a principal surface of the flat peripheral device is exposed and, at least in large part, overlaps with the housing, comprising a connector for supplying power to the flat peripheral device.
3.38. A flat peripheral device for use with a mobile electronic device, comprising:

a principal surface that is exposed during use of the flat peripheral device with the mobile electronic device and arranged to receive input from or provide output to a user of the mobile electronic device; and

a connector for receiving power from the mobile electronic device;

wherein the flat peripheral device has a form factor enabling it to be received within a sled-like structure of the mobile electronic device.
3.39. A method of zooming an image displayed on a mobile electronic device having touch input, comprising:

sensing a first user action pointing to an image region to be zoomed;

sensing a second user action in which a touch input is lifted differently than normal; and

in response to the second user action, performing a zoom operation on the image region.
3.40. The method of 3.39, wherein the second user action is sensed repeatedly, causing a zoom operation to be performed repeatedly on the image region.
3.41. A method of unzooming an image displayed on a mobile electronic device having touch input, comprising:

sensing a first user action pointing to an image region to be unzoomed;

sensing a second user action in which increased pressure is applied to a touch input; and

in response to the second user action, performing an unzoom operation on the image region.
3.42. The method of 3.41, wherein the second user action is sensed repeatedly, causing an unzoom operation to be performed repeatedly on the image region.
3.43. A method of panning an image displayed on a mobile electronic device having touch input, comprising:

sensing a user action having simultaneous rapid Z variation and XY variation; and

in response to the user action, performing panning of the image.

What is claimed is:

1. A method of entering text into a mobile electronic device, comprising:
sensing stylus input that is input on a surface through which information displayed on an electronic display is viewed; and
displaying on the electronic display an image of the stylus input as it is being input, the image of the stylus input being displayed in a translucent manner so as to less obscure underlying display information.

2. The method of claim 1, further comprising the mobile electronic device receiving a signal to perform a further operation on information representing the stylus input, the signal being produced by a user tapping a point on said surface.

3. The method of claim 2, wherein the further operation is one of the following: text recognition and transmission.

4. The method of claim 3, wherein the further operation is text recognition, wherein text recognition is performed taking into account probabilities of occurrence of word pairs or word tuples.

5. The method of claim 3, wherein the further operation is transmission, wherein transmission occurs simultaneously with voice transmission.

6. The method of claim 1, further comprising the mobile electronic device receiving a signal to perform a further operation on information representing the stylus input, the signal being produced by a user applying a finger touch to said surface.

7. The method of claim 1, wherein the further operation is one of the following: text recognition and transmission.

8. The method of claim 7, wherein the further operation is text recognition, wherein text recognition is performed taking into account probabilities of occurrence of word pairs or word tuples.

9. The method of claim 7, wherein the further operation is transmission, wherein transmission occurs simultaneously with voice transmission.

10. The method of claim 1, further comprising, in one mode of operation, performing transmission of information representing the stylus input on a sufficiently frequent basis that when the information is received and displayed, it appears to a user to be transmitted on a continuous basis.

11. A computer readable medium containing instructions for performing a method of entering text into a mobile electronic device, the method comprising the steps of:
sensing stylus input that is input on a surface through which information displayed on an electronic display is viewed; and
displaying on the electronic display an image of the stylus input as it is being input, the image of the stylus input being displayed in a translucent manner so as to less obscure underlying display information.

12. The computer readable medium of claim 11, said steps further comprising receiving a signal to perform a further operation on information representing the stylus input, the signal being produced by a user tapping a point on said surface.

13. The computer readable medium of claim 12, wherein the further operation is one of the following: text recognition and transmission.

14. The computer readable medium of claim 13, wherein the further operation is text recognition, wherein text recognition is performed taking into account probabilities of occurrence of word pairs or word tuples.

15. The computer readable medium of claim 13, wherein the further operation is transmission, wherein transmission occurs simultaneously with voice transmission.

16. The computer readable medium of claim 11, said steps further comprising receiving a signal to perform a further operation on information representing the stylus input, the signal being produced by a user applying a finger touch to said surface.

17. The computer readable medium of claim 11, wherein the further operation is one of the following: text recognition and transmission.

18. The computer readable medium of claim 17, wherein the further operation is text recognition, wherein text recognition is performed taking into account probabilities of occurrence of word pairs or word tuples.

19. The computer readable medium of claim 17, wherein the further operation is transmission, wherein transmission occurs simultaneously with voice transmission.

20. The computer readable medium of claim 11, said steps further comprising, in one mode of operation, performing transmission of information representing the stylus input on a sufficiently frequent basis that when the information is received and displayed, it appears to a user to be transmitted on a continuous basis.

21. A mobile electronic device comprising:
an input system for receiving user input;
an output system comprising an electronic display;
a controller coupled to the input system and to the output system, the controller being configured to:
sense stylus input that is input on a surface through which information displayed on the electronic display is viewed; and
display on the electronic display an image of the stylus input as it is being input, the image of the stylus input being displayed in a translucent manner so as to less obscure underlying display information.

22. The apparatus of claim 21, wherein the controller is configured to receive a signal to perform a further operation on information representing the stylus input, the signal being produced by a user tapping a point on said surface.

23. The apparatus of claim 22, wherein the further operation is one of the following: text recognition and transmission.

24. The apparatus of claim 23, wherein the further operation is text recognition, wherein text recognition is performed taking into account probabilities of occurrence of word pairs or word tuples.

25. The apparatus of claim 23, comprising a communications device, wherein the further operation is transmission, wherein transmission occurs simultaneously with voice transmission.

26. The apparatus of claim 21, wherein the controller is configured to receive a signal to perform a further operation on information representing the stylus input, the signal being produced by a user applying a finger touch to said surface.

27. The apparatus of claim 21, wherein the further operation is one of the following: text recognition and transmission.

28. The apparatus of claim 27, wherein the further operation is text recognition, wherein text recognition is performed taking into account probabilities of occurrence of word pairs or word tuples.

29. The apparatus of claim 27, comprising a communications device, wherein the further operation is transmission, wherein transmission occurs simultaneously with voice transmission.

30. The apparatus of claim 21, wherein the controller is configured to, in one mode of operation, perform transmission of information representing the stylus input on a sufficiently frequent basis that when the information is received and displayed, it appears to a user to be transmitted on a continuous basis.
